(19) United States
(12) Patent Application Publication
(10) Pub. No.: US 2009/0180132 A1
(43) Pub. Date: Jul. 16, 2009

(54) METHOD AND APPARATUS FOR RANDOMIZED PRINTING AND BIDIRECTIONAL SHIFTING

(75) Inventors: Eric Meyerhofer, Pasadena, CA (US); Kevin Rainbolt, Glendale, CA (US)

Correspondence Address: FITZPATRICK CELLA HARPER & SCINTO, 30 ROCKEFELLER PLAZA, NEW YORK, NY, 10112, US

(73) Assignee: FUTURELOGIC, INC., Glendale, CA (US)

(21) Appl. No.: 12/088,084

(22) PCT Filed: Oct. 4, 2006
(86) PCT No.: PCT/US06/38907

§ 371 Date: Nov. 7, 2008

Related U.S. Application Data
(60) Provisional application No. 60/723,786, filed on Oct. 4, 2005.

(51) Int. Cl. G06K 15/00

(52) U.S. Cl. 358/1.12; 358/1.16

(57) ABSTRACT

Method and apparatus for the randomized printing of transactions or voting records using a printer with a paper roll supply where after one area is printed, the paper is randomly shifted either in a one or bidirectional fashion to another area not adjacent to the previously printed area thus removing a set print record order and preserving randomness in print. A motorized paper roller is used for bidirectional paper shifting, an optical sensor is used to check if an area of paper roll is available for printing by reading indicia, procedures are used to randomly move the paper roll to prevent printing in a continuous motion, and a supply roll casing includes adequate spacing within to support the return of the paper roll during bidirectional paper shifting without rewinding the supply roll.

### CROSS-REFERENCE TO RELATED APPLICATION

This application claims the benefit of U.S. Provisional Patent Application No. 60/723,786, filed Oct. 4, 2005, the contents of which are hereby incorporated by reference as if stated in full herein.

### BACKGROUND OF THE INVENTION

1. Field of the Invention

This invention relates to printing of transaction records and more specifically to randomized printing of transactions or voting records using a printer with a paper roll supply.

2. Background

Currently, printers do not allow paper rolls to randomly shift to another area after printing one area on the paper or to shift in a bidirectional fashion. For example, in a voting printer that prints a voting record on a continuous paper roll; the printing is continuous from one record (or area of the paper) to the next. This presents a problem whereby the voting may not be anonymous as the voting order can be determined based on the printout on the paper roll.

This invention addresses this issue by providing a method and apparatus for shifting a paper roll in a one or bidirectional fashion thereby preserving randomness in the print order.

### DEFINITIONS

For the purposes of this document the following definitions apply:

“RRP”—an acronym for Random Record Printer.

“Transaction record”—a voter ballot, a receipt, or any other printed record of conducted business.

### SUMMARY OF THE INVENTION

A method and apparatus for randomized printing of transactions or voting records is provided. In a printer with a paper roll supply, after one area is printed, the paper is randomly shifted either in a one or bidirectional fashion to another area not adjacent to the previously printed area thus removing a set print record order and preserving randomness in print. A motorized paper roller is used for bidirectional paper shifting, an optical sensor is used to check if an area of paper roll is available for printing by reading indicia, procedures are used to randomly move the paper roll to prevent printing in a continuous motion, and a supply roll casing includes adequate spacing within to support the return of the paper roll during bidirectional paper shifting without rewinding the supply roll.

In one aspect of the invention, a Random Record Printer (herein called “RRP”) comprises a print mechanism, nonvolatile memory, a record view window, a paper roll supply, a paper path, one or a plurality of sensors, procedures, a motorized paper roller, a supply roll casing, and one or a plurality of tensioners, among other components.

In another aspect of the invention, the paper path comprises a print mechanism, one or a plurality of optical sensors, a tensioner, one or a plurality of paper path wheel tensioners, a roll of paper, the paper roll coupled from a supply roll to a record roll using the paper path.

In another aspect of the invention, a motorized paper roller shifts the paper roll back and forth between a supply roll and a record roll, the motorized paper roller pulling the paper roll through a paper path.

In another aspect of the invention, a supply roll casing comprises a device to support the return of the paper roll to a supply roll casing during bidirectional paper shifting without rewinding the supply roll, thereby controlling the paper roll.

In another aspect of the invention, a supply roll casing is coupled to a paper take up area.

In another aspect of the invention, a paper take up area comprises a device to support the return of the paper roll to a supply roll casing during bidirectional paper shifting without rewinding the supply roll, thereby controlling the paper roll.

In another aspect of the invention, the nonvolatile memory includes the ways and means to record the size of a transaction record, the gap size between transaction records, and/or the number of lines to print.

In another aspect of the invention, an optical sensor or a plurality of such includes the ways and means to scan the front (or thermal sensitive) side of the paper roll for indicia which identifies the area as already printed. If such exists, procedures are used to shift the paper to another unused area of the paper roll.

In another aspect of the invention, an optical sensor or a plurality of such includes the ways and means to scan the back (or non-thermal sensitive) side of the paper roll for indicia which identifies that area as already printed. If such exists, procedures are used to shift the paper to another unused area of the paper roll.

In another aspect of the invention, a tensioner or plurality of such includes the ways and means to provide tension on the paper roll in the paper path to prevent slack in the paper roll.

In another aspect of the invention, a paper path wheel tensioner or plurality of such includes the ways and means to provide tension on the paper path wheel.

In another aspect of the invention, a print mechanism includes the ways and means to print transaction records on the paper roll, the print mechanism being a non-impact type such as thermal, laser, inkjet, or dye-sublimation, or impact type such as dot matrix.

In another aspect of the invention, an RRP includes the ways and means to print transaction records using procedures and motorized paper rollers to randomly shift either in a one or bidirectional fashion to another area not adjacent to the previously printed area.

In another aspect of the invention, an RRP includes the ways and means to encode the paper roll with data such as text or plurality of text, one or a plurality of graphics, indicia such as beginning and end of form markers, index or tick marks, a plurality of such or a combination of such, the encoding being read by the optical sensor to determine if the print area is available for printing or already used. If the print area contains a transaction record, the paper roll is shifted in a bidirectional method to an available print area.

In another aspect of the invention, the transaction record comprises indicia such as text or a plurality of text such as ballot information or graphics or a plurality of graphics such as the logo of a governing agency or business entity.

In another aspect of the invention, the paper roll may comprise preprinted indicia such as markers that identify the beginning and end of a transaction record. The preprinted indicia may be either on the thermal sensitive or non-thermal sensitive side of the paper roll. The preprinted indicia are read by an optical sensor or plurality of such to determine the beginning or end of a transaction record.

In another aspect of the invention, indicia are printed and encoded by the RRP with beginning and ending markers, tick marks, or a combination thereof which are used to identify an area of the paper roll upon which printing has already occurred.

In another aspect of the invention, indicia are of a fixed value as determined by procedures and the attributes of the printout such as the length of the transaction record, number of lines of print or tick marks.

In another aspect of the invention, a record view window provides the means by which users may view their transaction record.

In another aspect of the invention, a random value generator in the RRP may determine the procedure used in the bidirectional movement of the paper roll for randomizing the print order of transaction records before sequentially printing transaction records.

In another aspect of the invention, procedures are used to signal the RRP to generate a transaction record. The RRP and components thereof pulls the supply roll through a printing mechanism wherein the supply roll is encoded with transaction data to create a transaction record, the transaction record is then pulled along the paper path moving towards the record roll.

In another aspect of the invention, procedures are used to signal the RRP to bidirectional shift the paper roll, and then generate a transaction record. The RRP and components thereof may pull from either the supply roll or record roll through a printing mechanism wherein the paper roll is encoded with transaction data to create a transaction record, the transaction record is then pulled along the paper path moving either towards the record roll or the supply roll.

In another aspect of the invention, the procedure may also be set to a predetermined number of paper shifts that may occur at any given time.

In another aspect of the invention, procedures are used to determine the size of transaction record to print on a paper roll.

In another aspect of the invention, procedures are used to determine the size of the gap between each transaction record printed on a paper roll.

In another aspect of the invention, procedures are used to void over a transaction record.

### BRIEF DESCRIPTION OF THE DRAWINGS

These and other features, aspects, and advantages of the present invention will become better understood with regard to the following description and accompanying drawings where:

FIG. 1 is an illustration of the paper path and supply roll casing of an RRP and components thereof in accordance with an exemplary embodiment of the present invention.

FIG. 2 is an illustration of a supply roll casing with a paper take up area in accordance with an exemplary embodiment of the present invention.

FIG. 3 is a diagram of possible data elements and parameters, which may be used with procedures for randomized bidirectional paper, roll shifting procedure in accordance with an exemplary embodiment of the present invention.

FIG. 4 is a process diagram for randomized paper roll shifting in a bidirectional fashion using procedures in accordance with an exemplary embodiment of the present invention.

FIG. 5 is a process diagram for predetermined paper roll shifting in a bidirectional fashion using procedures in accordance with an exemplary embodiment of the present invention.

FIG. 6 is an illustration of the front side of a transaction record including indicia in accordance with an exemplary embodiment of the present invention.

FIG. 7 is an illustration of the backside of a transaction record including indicia in accordance with an exemplary embodiment of the present invention.

FIG. 8 is an illustration of the face of a transaction record including indicia and a VOID stamp in accordance with an exemplary embodiment of the present invention.

FIG. 9 is an illustration of a record view window of an RRP in accordance with an exemplary embodiment of the present invention.

### DETAILED DESCRIPTION

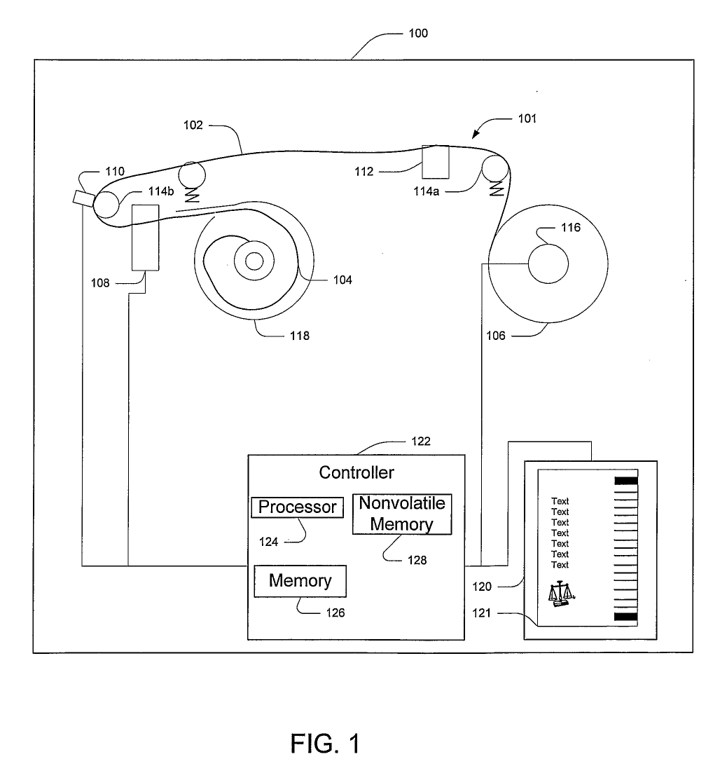

FIG. 1 is an illustration of the paper path of an RRP and components thereof in accordance with an exemplary embodiment of the present invention.

As shown, an RRP 100 includes a paper path 101 that includes a paper roll 102 traveling to and from a supply roll 104 and a record roll 106. As the paper roll travels to and from the supply roll and record roll, the paper roll passes through a print mechanism 108, an optical sensor 110, a tensioner 112, and one or more paper path wheel tensioners 114a and 114b.

The paper path further includes a motorized paper roller 116 for the record roll. The motorized paper rollers shift the paper roll freely back and forth between the supply paper spool and the record paper spool by pulling the paper roll through the paper path thus shifting the paper roll in a one or bidirectional fashion to allow randomized printing of transaction records.

During bidirectional shifting of the paper roll from the record roll to the supply roll along the paper path, a supply roll casing 118 accommodates excess paper from the paper roll, thereby containing a portion of the paper roll when the paper roll is returned to the supply roll casing. Instead of the paper roll being returned to the supply roll, the paper roll may fill up an additional area in the supply roll casing. For example, using a procedure which reverses the paper roll a number of print areas before printing, the RRP may feed the number print areas back into the supply roll casing, thereby occupying a portion of the excess space in the supply roll casing.

A record view screen 120 is used to display to a user a transaction record 121 that was printed.

The supply roll of paper supplies the blank paper stock available for printing. The record roll of paper holds the transaction records printed on the blank paper stock from the supply roll.

The print mechanism is used to print transaction records on the paper roll. The print mechanism may be a non-impact type such as thermal, laser, inkjet, or dye-sublimation, or impact type such as dot matrix.

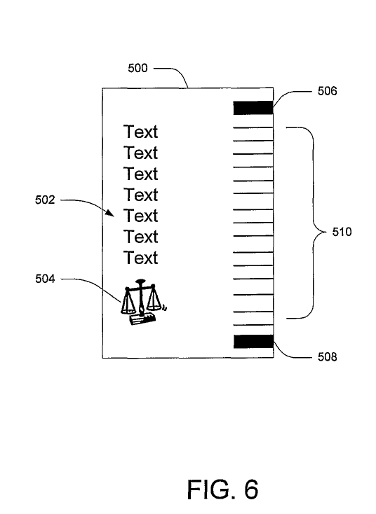

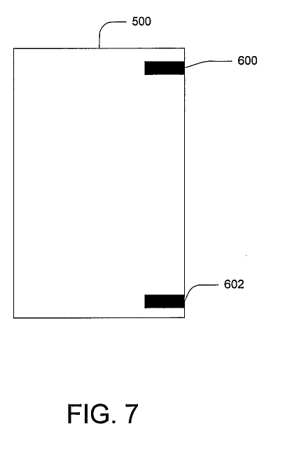

The optical sensor or plurality of such is used to scan the paper roll for the existence of transaction data by reading indicia which identifies an area as already printed, the indicia as later described in FIG. 6 and FIG. 7.

The tensioner is used to provide tension on the paper roll in the paper path to prevent slack in the paper roll. A paper path wheel tensioner (not shown) or a plurality of such is used to provide tension on the paper path wheel.

A controller 122 controls the operation of the components of the RRP 100. The controller is coupled to the motorized paper rollers, the print mechanism the optical sensor and the record view screen. The controller includes a processor 124 coupled to a memory 126 holding data and processor executable instructions executable by the processor to implement the features of a RRP as described herein. The controller further includes a nonvolatile memory 128 for storing parameter values for the paper roll.

Although described in terms of a controller having a processor, a memory and executable memory instructions, it is to be understood that the controller 122 can be implemented using any device capable of executing a logical operation, such as a general purpose computer, a preprogrammed logic controller, one or more hardware circuits, etc.

In operation, the printer receives instructions from an external device 130 to print a transaction record. In response to the instructions, the printer prints the transaction record on an area of the paper roll. After one area on the paper roll is printed, the paper roll is randomly shifted either in a one or bidirectional fashion to another area not adjacent to the previously printed area thus removing a set print record order and preserving randomness in print. The motorized paper rollers are used for bidirectional paper shifting, the optical sensor is used to check if an area of paper roll is available for printing by reading indicia, and the controller uses various procedures to randomly move the paper roll to prevent printing in a continuous direction.

During operation, the controller uses the nonvolatile memory to record the size of a transaction record, the gap size between transaction records, and/or the number of lines to print. In this way, the controller can track the locations of the previously printed areas to determine which areas of the paper roll can still be printed.

The optical sensor or a plurality of such scans the print or front side of the paper roll for indicia on the paper roll (not shown) that identify an area as already printed. If such indicia exist, the controller shifts the paper to another unused area of the paper roll.

Additionally, another optical sensor or a plurality of such (not shown) may scan the non-print or back side of the paper roll for indicia which identify an area as already printed. If such exists, the controller shifts the paper to another unused area of the paper roll.

In another embodiment of a RRP in accordance with the present invention, a passive paper roller may be used to support the supply roll.

In another embodiment of a RRP in accordance with the present invention, a supply roll casing may comprise a supply roll and passive paper roller. The supply roll casing may be used to support the return of the paper roll during bidirectional paper shifting without rewinding the supply roll, with the supply roll casing providing adequate spacing for the returned paper roll.

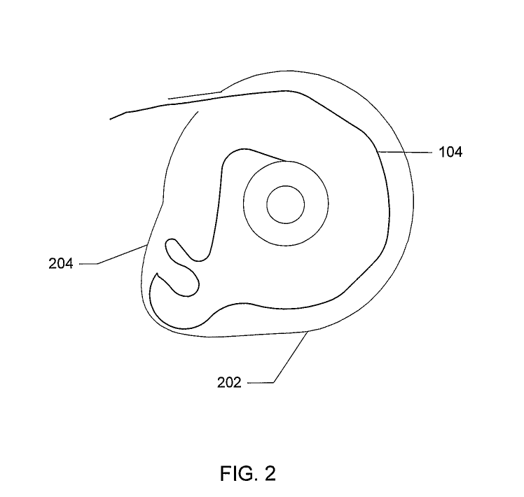

FIG. 2 is an illustration of a supply roll casing with a paper take up area in accordance with an exemplary embodiment of the present invention.

This illustration identifies another supply roll casing that may be used in lieu of the supply roll casing 118 previously described in FIG. 1. Referring to FIG. 2, a supply roll casing 202 may include to a paper take up area 204. During bidirectional shifting of the paper roll from the record roll to the supply roll along the paper path, the paper take up area accommodates excess from the paper roll when the paper roll is returned to the supply roll casing.

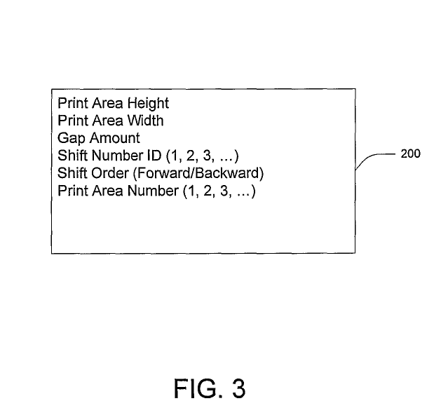

FIG. 3 illustrates a table 200 of data elements and parameters that are used with procedures for randomized one or bidirectional paper roll shifting in accordance with an exemplary embodiment of the present invention.

As shown, a portion of possible data elements and parameters include Print Area Height, Print Area Width, Gap Amount, Shift Number ID, Shift Order, and Print Area Number. Any or all of these data elements and parameters is stored in nonvolatile memory.

Print Area Height identifies the height of the transaction records. The unit of measure may be any unit of measure for determining size.

Print Area Width identifies the width of the transaction records. The unit of measure may be any unit of measure for determining size.

Gap Amount identifies any gap or blank space between transaction records. The unit of measure may be any unit of measure for determining size.

Shift Number ID uses sequential numbering which may begin with 1 to identify each shift in the paper roll. Multiple paper shifts may be created using a unique shift number ID.

Shift Order identifies the shift in the paper roll as either forward or backward for each shift number ID.

Print Area Number identifies print areas on the paper roll.

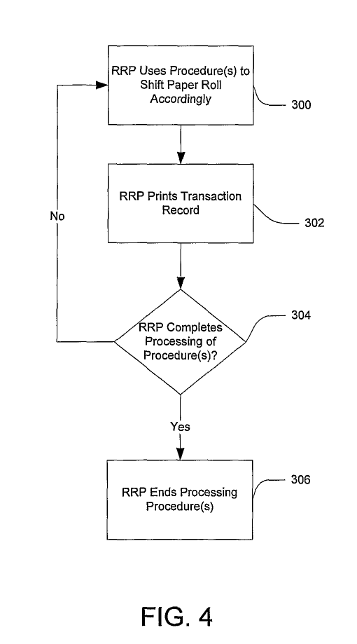

FIG. 4 is a process flow diagram for randomized paper roll shifting in a one or bidirectional order using procedures in accordance with an exemplary embodiment of the present invention.

As shown, the process begins with the RRP using procedures to determine a shift (300) of the paper roll, either forward or backward, to allow bidirectional shifting of the paper roll to achieve randomized printing, after which the RRP prints (302) a transaction record.

The process continues by either looping back to the shifting determination procedure if the RRP has not completed processing the procedure (304) or ending the process (306).

An example the procedure for bidirectional paper shifting would be as follows:

0+5 <Shift1>−3 <Shift2>+7 <Shift3>−3 <Shift4>

where:

Shift1=move the paper roll forward 5 areas to area #5, whereupon a transaction record is printed.

Shift2=move the paper roll back 3 areas to area #2, whereupon a transaction record is printed.

Shift3=move the paper roll forward 7 areas to area #9, whereupon a transaction record is printed.

Shift4=move the paper roll back 3 areas to area #6, whereupon a transaction record is printed.

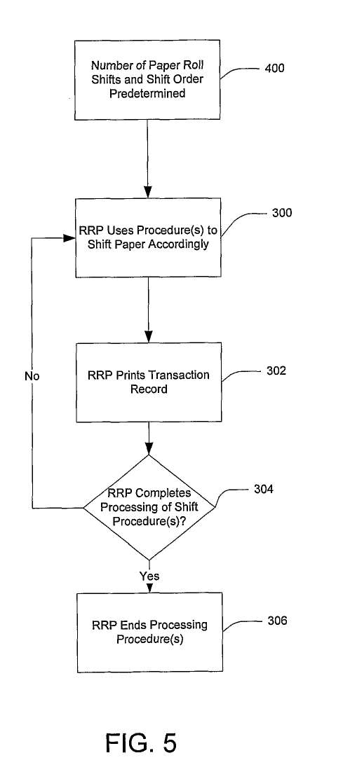

FIG. 5 is a process diagram for predetermined paper roll shifting in a bidirectional order using procedures in accordance with an exemplary embodiment of the present invention.

As shown, the process begins with the number of paper roll shifts and shift order being predetermined (400), after which the process is identical to that of FIG. 4.

An example of a procedure for predetermining the number of shifts that may occur at any given time would be as follows:

5 <Predetermined_Shift_Value>=0+9 <Shift1>−4 <Shift2>−2 <Shift3>+3 <Shift4>+4 <Shift5>

where:

Predetermined_Shift_Value=the predetermined number of times the RRP and components thereof would shift the paper roll before sequentially printing transaction records.

Shift1=move the paper roll forward 9 areas to area #9, whereupon a transaction record is printed.

Shift2=move the paper roll back 4 areas to area #5, whereupon a transaction record is printed.

Shift3=move the paper roll back 2 areas to area #3, whereupon a transaction record is printed.

Shift4=move the paper roll forward 3 areas to area #6, whereupon a transaction record is printed.

Shift5=move the paper roll forward 4 areas to area #10, whereupon a transaction record is printed.

In one embodiment of a RRP, a random number generator in the RRP is used determine the procedure used in the bidirectional movement of the paper roll for randomizing the print order of transaction records before sequentially printing transaction records.

In another embodiment, the procedure may also be set to a predetermined number of paper shifts that may occur at any given time.

In another embodiment of the present invention, procedures are used to determine the size of transaction record to print on a paper roll.

In another embodiment of the present invention, procedures are used to determine the size of the gap between each transaction record printed on a paper roll.

FIG. 6 is an illustration of a printable or front side of a transaction record including indicia in accordance with an exemplary embodiment of the present invention.

As shown, a transaction record 500 includes text 502 or a plurality of such, a graphic 504 or plurality of such, or a combination of text and graphics. Text may include a date, and/or a time. A graphic may be a barcode or a logo.

A transaction record may also include indicia such as beginning 506 and end 508 of form markers, tick marks 510, or a combination thereof, the indicia identifying a printed area or transaction record. The indicia may be preprinted on the paper roll or printed and encoded by the RRP simultaneously with the transaction record. The indicia are read by an optical sensor or plurality of such to determine the beginning and end of a transaction record. The indicia are of a fixed value as determined by the attributes set using procedures, the attributes that may include length of the transaction record, number of lines to print, or tick marks, among others.

FIG. 7 is an illustration of the non-printing or backside of a transaction record 500 including indicia in accordance with an exemplary embodiment of the present invention.

As shown, the backside of a transaction record may comprise indicia such as beginning 600 and end 602 of form markers, the indicia identifying a printed area or transaction record. The indicia may be preprinted on the paper roll or printed and encoded by the RRP simultaneously with the transaction record.

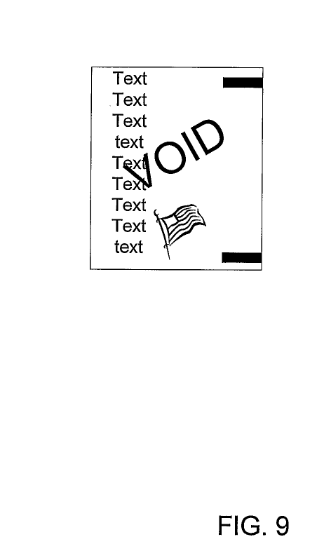

FIG. 8 is an illustration of the face of a transaction record including indicia and a VOID stamp in accordance with an exemplary embodiment of the present invention.

As shown, a VOID stamp 900 is printed over an existing transaction record such as that described in FIG. 6. For example, if the transaction record is to be voided, the RRP uses a sensor or a plurality of such to read encoding on a transaction record, after which procedures are used to retract the transaction record through the paper path and return the transaction record to the printing mechanism. The printing mechanism prints over the transaction record with a VOID stamp after which the transaction record is pulled along the paper path.

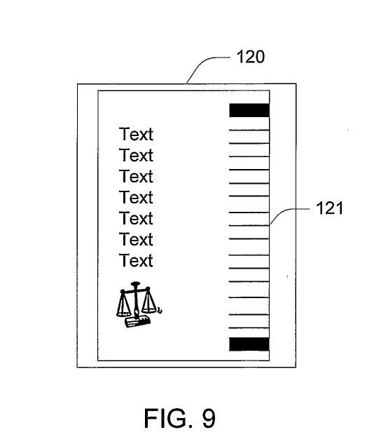

FIG. 9 is an illustration of a record view window 120 of an RRP in accordance with an exemplary embodiment of the present invention.

As shown, a printed transaction record 121 is available for viewing using the record view window where a user may review the transaction record. For example, in a voting booth, after a voter casts their ballot, the voter may view the ballot using the record view window to determine if the ballot is correct. If the contents are incorrect, the RRP using procedures may void the transaction record and print a new transaction record after the user reenters ballot information.

Although the present invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims3 equivalents rather than the foregoing description.

What is claimed is:

1. A method of randomly printing transaction records, comprising:
printing a transaction record on a first area of a paper roll, the paper roll housed in a supply roll casing;
randomly shifting to a second area of the paper roll by returning a portion of the paper roll to the supply roll casing without rewinding the paper roll, the second area not adjacent to the first area of the paper roll; and
printing a subsequent transaction record on the second area of the paper roll, whereby a set print record order of the transaction record and the subsequent transaction record is removed and a randomness in the print order of the transaction record and the subsequent transaction record is preserved.

2. The method of claim 1, further comprising reading indicia on a print side of the paper roll to determine if an area of the paper roll is available for printing.

3. The method of claim 1, further comprising reading indicia on a non-print side of the paper roll to determine if an area of the paper roll is available for printing.

4. The method of claim 1, further comprising recording a size of the transaction record printed on the paper roll in a nonvolatile memory.

5. The method of claim 1, further comprising recoding a gap size between transaction records printed on the paper roll in a nonvolatile memory.

6. The method of claim 1, further comprising recording a number of lines to print for the transaction record.

7. The method of claim 1, further comprising displaying to a user the transaction record on a record view screen.

8. The method of claim 7, further comprising voiding the transaction record by the user.

9. A printer for randomly printing transaction records, comprising:
means for printing a transaction record on a first area of a paper roll;
means for randomly shifting to a second area of the paper roll, the second area not adjacent to the first area of the paper roll; and
means for printing a subsequent transaction record on the second area of the paper roll, whereby a set print record order of the transaction record and the subsequent transaction record is removed and a randomness in the print order of the transaction record and the subsequent transaction record is preserved.

10. The printer of claim 9, further comprising means for reading indicia on a print side of the paper roll to determine if an area of the paper roll is available for printing.

11. The printer of claim 9, further comprising means for reading indicia on a non-print side of the paper roll to determine if an area of the paper roll is available for printing.

12. The printer of claim 9, further comprising means for recording a size of the transaction record printed on the paper roll in a nonvolatile memory.

13. The printer of claim 9, further comprising means for recoding a gap size between transaction records printed on the paper roll in a nonvolatile memory.

14. The printer of claim 9, further comprising means for recording a number of lines to print for the transaction record.

15. The printer of claim 9, further comprising means for displaying to a user the transaction record on a record view screen.

16. The printer of claim 15, further comprising means for voiding the transaction record by the user.

17. A system for randomly printing transaction records, comprising:
a paper roll comprising preprinted indicia identifying areas for printing of the transaction records; and
a printer comprising:
means for printing a transaction record on a first area of a paper roll, the paper roll housed in a supply roll casing;
means for randomly shifting to a second area of the paper roll by returning a portion of the paper roll to the supply roll casing without rewinding the paper roll, the second area not adjacent to the first area of the paper roll; and
means for printing a subsequent transaction record on the second area of the paper roll, whereby a set print record order of the transaction record and the subsequent transaction record is removed and a randomness in the print order of the transaction record and the subsequent transaction record is preserved.

18. The system of claim 17, the printer further comprising means for reading indicia on a print side of the paper roll.

19. The system of claim 17, the printer further comprising means for reading indicia on a non-print side of the paper roll.

20. The system of claim 17, the printer further comprising means for recording a size of the transaction record printed on the paper roll in a nonvolatile memory.

21. The system of claim 17, the printer further comprising means for recoding a gap size between transaction records printed on the paper roll in a nonvolatile memory.

22. The system of claim 17, the printer further comprising means for recording a number of lines to print for the transaction record.

23. The system of claim 17, the printer further comprising means for displaying to a user the transaction record on a record view screen.

24. The system of claim 23, the printer further comprising means for voiding the transaction record by the user.

25. The system of claim 17, wherein the supply roll casing further includes a paper take up area for storing the returned portions of the paper roll.
